(19) United States
(12) Patent Application Publication
(10) Pub. No.: US 2010/0014097 A1
(43) Pub. Date: Jan. 21, 2010

(54) ALGORITHM CORRECTING FOR CORRECTION OF INTERFEROMETER FLUCTUATION

(75) Inventor: Michael R. Sogard, Menlo Park, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/502,099

(22) Filed: Jul. 13, 2009

Related U.S. Application Data
(60) Provisional application No. 61/081,631, filed on Jul. 17, 2008.

(51) Int. Cl. G01B 11/14

(52) U.S. Cl. 356/498

(57) ABSTRACT

An exemplary interferometer system includes an interferometer producing data from at least one interferometer beam. A source of gently flowing gas or gas mixture (atmosphere) produces a gas flow substantially normal to the beam pathway. A perturbation source (e.g., resistance heater) upstream of the beam pathway produces, in a repetitively pulsed manner, perturbed loci in the flowing atmosphere in selected locations upstream of the beam pathway. The perturbed loci flow to the interferometer beam(s). Data from the interferometer are received by a processor programmed with an algorithm that calculates, based on the data obtained during a perturbation pulse, the effect of the perturbed loci on the at least one interferometer beam as the loci pass through the interferometer beam. The processor also updates the algorithm based on data obtained from the interferometer during a subsequent perturbation pulse, compared to a previous perturbation pulse.

### CROSS-REFERENCE TO RELATED APPLICATION

This application claims priority to, and the benefit of, U.S. Provisional Application No. 61/081,631, filed on Jul. 17, 2008, which is incorporated herein by reference in its entirety.

### FIELD

This disclosure pertains to, inter alia, interferometric position-measuring devices and methods for determining position of a first object relative to a second object or relative to a location, such as, for example, position of a stage relative to an optical system or to an axis of the optical system in a microlithographic exposure system.

### BACKGROUND

The proper functioning of various systems and apparatus relies upon an ability to position an object, such as a workpiece, accurately and precisely, such as relative to a machining tool, processing tool, or imaging device. Object placement is perhaps most critical in lithographic exposure systems used in the fabrication of microelectronic devices, displays, and the like. These systems, called microlithography systems, must satisfy extremely demanding criteria of image-placement, image-resolution, and image-registration on the lithographic substrate. For example, to achieve feature sizes, in projected images, of 100 nm or less on the substrate, placement of the substrate for exposure must be accurate at least to within a few nanometers or less. Such criteria place enormous technical demands on stages and analogous devices used for holding and moving the substrate and for, in some systems, holding and moving a pattern-defining body such as a reticle or mask.

The current need for stages capable of providing extremely accurate placement and movement of reticles, substrates, and the like has been met in part by using laser interferometers for determining stage position. Microlithography systems typically use at least two perpendicular sets of laser interferometer beams to measure the horizontal (x-y) two-dimensional position of a stage movable in the x and y directions. The stage and interferometer system are enclosed in an environmental chamber containing a flow of highly filtered and temperature-controlled air, in part to prevent deposition of particulate matter on the lithographic substrate or on the reticle. The environmental chamber thus assists in maintaining the index of refraction of the air at a substantially constant value by maintaining constancy of the air temperature.

In many types of microlithography systems, a projection-optical system (“projection lens”) is situated between a reticle stage and a substrate (wafer) stage. The projection lens is rigidly mounted on a rigid, vibration-isolation support to suppress motion of the projection lens. The projection lens must remain very still during the making of lithographic exposures from the reticle to the substrate.

In view of the importance of aligning the stages very accurately with the projection lens, the projection lens (or stable structure to which the projection lens is mounted) is often used as a reference body for determining the position of the stages. In other words, the respective position of each stage is determined relative to the projection lens. For such a purpose, reference mirrors for reflecting reference interferometer beams are mounted to the column containing the projection lens. Usually, for each stage two reference mirrors (at right angles to each other) are provided on the projection lens, one for reflecting x-direction reference interferometer beams and the other for reflecting y-direction reference interferometer beams.

This scheme is illustrated in FIGS. 1(A)-1(C), showing a projection lens 202, a stage 204 (e.g., wafer stage), one x-direction “fixed” reference beam 206 produced by an x-direction reference interferometer 208, and two y-direction reference beams 210, 212. The x-direction reference beam 206 is incident on the mirror 214, and the y-direction reference beams 210, 212 are incident on the mirror 216. The mirrors 214, 216 are at right angles to each other and are mounted on or at least associated with the projection lens 202. Associated with the x-direction reference beam 206 is an x-direction measurement beam 218, produced by an x-direction measurement interferometer 220, incident on a mirror 222 on the stage 204. Similarly, associated with each y-direction reference beam 210, 212 is a respective y-direction measurement beam (not shown) incident on the stage 204. These two y-direction measurement beams are used for detecting yaw of the stage 204 (i.e., motions of the stage about the axis Ax extending in the z-direction). Additional interferometer beams may be present to provide corrections to the stage position from other motions of the stage, such as pitch, roll, or height.

Stage position in the x-direction, for example, can then be corrected for small motions of the lens, by subtracting the lens x-position, determined from the x-direction reference beam 206, from the stage x-position. If the stage is traveling only in the x-direction, the length of the x-direction reference beam 206 can be subtracted directly from the x-direction measurement beam 218. If the stage motion is not purely in the x-direction, the length of the x-direction reference beam 206 is subtracted from the x-displacement component, which is calculated from measurement information obtained from the stage-measurement interferometers. This correction method assumes any changes in the path-length of the x-direction reference beam 206 are caused by motion of the projection lens 202. However, if the optical path-length of the x-direction reference beam 206 changes because the optical properties of the ambient atmosphere change, an erroneous correction to the position of the projection lens 202 will be produced.

Fluctuations in the optical path-length of the x-direction measurement beam 218, caused by changes in the optical properties of the ambient atmosphere through which the beam propagates, will cause further errors in the stage position. For example, air experiencing local variations in temperature exhibits corresponding variations in density and refractive index. If air turbulence is occurring in the propagation pathway of an interferometer beam, the turbulence can form regions, or cells, of air of different refractive indices. The cells change the optical path length of the beam, and thus degrade the accuracy and precision of positional measurements determined by the interferometer. Various approaches have been adopted to address this problem, notably by enclosing the stages and interferometers in an environmental chamber, as noted above, and by producing and maintaining improved (gentle laminar flow and constant temperature) air circulation in the vicinity of the interferometers and stages. Exemplary approaches are discussed in, for example, U.S. Pat. No. 4,814,625 to Yabu, U.S. Pat. No. 5,141,318 to Miyazaki, and U.S. Pat. No. 5,870,197 to Sogard et al., all incorporated herein by reference. In general, referring again to FIGS. 1(A)-1(C), the corresponding reference and measurement beams 206, 218 are situated as close as possible to each other and have similar respective lengths. The beams 206, 218 are situated in a stream of air (arrows 224) flowing from the reference beam(s) to the measurement beam(s). The air flow 224 is at a right angle to the beams 206, 218.

It has been proposed to use air-temperature fluctuations in the pathway of a wafer-stage reference interferometer beam, which propagates to a fixed mirror on the projection lens, to correct for air fluctuations in a wafer-stage measurement interferometer beam that is close to the reference beam but downstream from and parallel to it. The general concept is that air fluctuations contained in the down-flow of air perturb the reference beam, and that these air fluctuations propagate substantially unchanged from the reference beam to the measurement beam where the fluctuations contribute similar perturbations. However, the fluctuations at the measurement beam are actually not identical to the fluctuations at the reference beam. Also, there is a time delay in air flow from the reference beam to the measurement beam that depends upon the air-flow velocity, and the air-flow velocity in this region fluctuates in time. Consequently, a simple static predictive algorithm does not provide sufficiently accurate predictions. In this regard, reference is made to U.S. Patent Publication No. US-2008/0291464-A1, incorporated herein by reference.

The conventional algorithm operates “open loop,” without feedback from the measurement signal to check the algorithm during operation. In FIG. 2 the reference interferometer beam 206 reflects from a mirror 214 on the projection lens 202, and the measurement interferometer beam 218 reflects from a mirror 222 on the stage 204. Air flow is indicated by the arrows 224. A stage controller 230 is connected to the stage 204. The stage controller 230 controls execution of an algorithm 232 according to data 234 from the reference interferometer 208. The algorithm 232 determines reference data 236 (not shown in FIG. 2) that includes the effects of detected fluctuations in the reference interferometer beam 206. Measurement data 238 obtained by the measurement interferometer 220 are compared with the reference data 236 to produce “fluctuation-corrected” measurement-interferometer data 240.

Operating open loop, the data obtained from the conventional algorithm concerning measurement-beam fluctuations are not checked in real time. Rather, only an initial calibration is performed, based on a difference measurement. Thus, especially over time, there is also no way to check that the measurement-beam fluctuations have been corrected accurately by the algorithm 232. The calibration is performed using, for example, field image alignment (FIA) measurements of alignment marks.

Air fluctuations are associated with turbulence in the air flow, and turbulence is a non-stationary process that cannot be entirely addressed by operation of a fixed (unchanging or non-adaptable) algorithm. For example, in an air stream, air-flow velocity tends to fluctuate somewhat in time and space. FIG. 3 shows a plot, obtained in an analysis of air flow in an interferometer test fixture, of the time-delay of correlated cells of air traveling between two parallel interferometer beams. The unit of time delay on the ordinate is given as “lags.” One “lag” is equal to a time delay of 1.536 millisecond. Ideally, FIG. 3 is a straight line, but that is not actually the case. If the time-delay varies as shown, then predicted corrections may be applied out of phase with actual fluctuations in the measurement, leading to error. (In this regard, “phase” is related to the delay time of a perturbation between the reference and measurement beams.) Similarly, the cells of air of varying index of refraction may change shape or size as they travel from the first beam to the second beam, also leading to error.

As described in the '464 application mentioned above, it is possible to improve performance over the conventional algorithm by introducing an adaptive algorithm, or adaptive filter, that changes its properties with changes to the air-flow properties, such as changes in time delay or large-scale properties of the air flow. The '464 application describes an adaptive filter that predicts fluctuations in a measurement interferometer beam from fluctuations in a reference interferometer beam located in the same air flow from the measurement beam. Obtaining real-time fluctuation information from the measurement beam, in order to update the parameters of the adaptive filter, is however very difficult because the fluctuations have to be separated from the much larger changes to the measurement interferometer signal from stage motion.

A better application of adaptive filters is to provide a second, redundant reference interferometer beam that is parallel to and upstream from the first reference interferometer beam. As described in the '464 application an adaptive filter can be constructed that predicts fluctuations in both the measurement-interferometer beam and the first reference-interferometer beam. The adaptive filter parameters are updated based on the measured fluctuations in the first reference-interferometer beam. It must be assumed that the changes to the air-flow properties, recorded between the two reference interferometer beams, must apply as well to the measurement-interferometer beam and the first reference-interferometer beam. This algorithm is believed to be superior to the simple open-loop algorithm.

However, adding a second reference interferometer beam may be difficult and/or expensive, since space is typically very limited near the projection lens, and a very high degree of mechanical stability is required in order to make the addition worthwhile.

In view of the above, an algorithm is needed that is not fixed, but rather is updated sufficiently frequently, and which is compact, easy to install, and relatively inexpensive.

### SUMMARY

The deficiencies of the prior art summarized above are resolved using interferometer systems and methods according to various aspects of the invention, as summarized below. According to one aspect, an interferometer system is provided that comprises an interferometer that produces data from at least one interferometer beam. The system also includes a source of a gently flowing gas or gas mixture (atmosphere) that flows substantially normal to the beam pathway. A perturbation source (such as, but not limited to, a resistance heater) is situated upstream of the beam pathway. The perturbation source produces, in a repetitively pulsed manner, perturbed loci in the flowing atmosphere in selected locations upstream of the beam pathway, such that the perturbed loci flow to the at least one interferometer beam. Data from the interferometer are received by a processor. The processor is programmed with an algorithm that calculates, based on the data obtained during a perturbation pulse, the effect of the perturbed loci on the at least one interferometer beam as the loci pass through the interferometer beam. The processor also updates the algorithm based on data obtained from the interferometer during a subsequent perturbation pulse, compared to a previous perturbation pulse.

The perturbations in the interferometer beam typically produce respective peaks or analogous features in the interferometer signal. Passing the interferometer data through, for example, a low-pass filter or band pass filter isolates the peaks reasonably well by removing high-frequency components of the signal. In other words, the signal fluctuations arising from operation of the perturbation source are separable from other fluctuations, especially if the fluctuations from the perturbation source occur at an approximately fixed repetition rate and amplitude. Although the fluctuations tend to increase the total interferometer fluctuations to be removed, the algorithm corrects for the fluctuations.

The interferometer system desirably includes at least a reference interferometer that produces at least one reference interferometer beam. The interferometer system also can comprise a measurement interferometer that produces data from at least one measurement interferometer beam. These data are compared by the processor with data obtained from the reference interferometer beam. The measurement-interferometer beam desirably propagates parallel to the reference-interferometer beam and is situated such that the flowing atmosphere, with perturbed loci, reaches the measurement-interferometer beam after passing across the reference-interferometer beam pathway.

In some embodiments an exemplary perturbation source is a resistance heater or other heat source situated in the flowing atmosphere upstream of the interferometer beam. A repetitively pulsed power source is connected to the heater and operated to produce loci (“cells”) of heated air. These cells are carried along by the flowing atmosphere to the interferometer beam(s) where the cells cause corresponding fluctuations in the beams. A particularly effective configuration of resistance heater comprises at least one wire extending parallel to the interferometer-beam pathway, normal to the flow direction of the atmosphere and upstream of the interferometer beams.

In embodiments including at least one reference interferometer and at least one measurement interferometer, the respective interferometer beams are located in the flowing atmosphere and propagate parallel to each other in a direction normal to the direction of flow of the atmosphere. For example, the measurement interferometer beam is located downstream of the reference interferometer beam. A processor connected to the reference and measurement interferometers is programmed with an algorithm that, based on received data (including the fluctuations) from the interferometers, calculates corrections to the measurement-beam data based on detected time delays of the fluctuations in the reference and measurement beams. The processor can be further configured to detect changes in amplitude of the interferometer signals caused by the perturbation source and to determine amplitude corrections based on the detected changes.

The system can further comprise a filter connected to the reference interferometer to isolate perturbations of data from the reference interferometer caused by the perturbation source heating the atmosphere flowing past the reference and measurement beams. For improved detection of perturbation peaks in the interferometer signals, the system can further comprise a low-pass filter connected between the reference interferometer and the filter.

According to another aspect, methods are provided determining the position of an object using interferometry. An embodiment of the method comprises directing an interferometer beam along a beam pathway to the object so as to reflect from the object. The interferometer beam thus produces data from the interferometer beam regarding position of the object. Meanwhile, flow of an atmosphere is directed substantially normal to the beam pathway. In a repetitively pulsed manner, a pulses of perturbed loci are produced in selected locations in the flowing atmosphere upstream of the beam pathway such that the perturbed loci flow to and across the beam pathway. Using an algorithm, data are produced from the interferometer beam as the perturbed loci pass across the beam pathway(s) during the perturbation pulse. During a subsequent perturbation pulse, data from the interferometer beam reflect the perturbation as the respective perturbed loci pass across the beam pathway. The algorithm is updated based on changes in the data obtained during the subsequent pulse compared to data obtained during the first pulse.

The various aspects of the invention summarized below provide greater accuracy in determinations of position and movement performed by interferometry. Obtaining this greater accuracy is especially important in precision systems including one or more interferometers. An example precision system is, but is not limited to, a microlithography system used for exposing patterns of extremely small features onto the exposure-sensitive surface of a lithographic substrate such as a semiconductor wafer.

The foregoing and additional features and advantages of the subject invention will be more apparent from the following detailed description, which proceeds with reference to the accompanying drawings.

### BRIEF DESCRIPTION OF THE DRAWINGS

FIGS. 1(A)-1(C) are respective orthogonal views of a conventional manner of interferometrically determining position of a stage relative to a projection lens.

FIG. 2 is a control diagram of a conventional open-loop manner of controlling position and movement of a substrate stage.

FIG. 3 is a plot, obtained in an analysis of air flow in a conventional interferometer test fixture, of the time-delay of correlated cells of air traveling between two parallel interferometer beams.

FIGS. 4(A)-4(B) are orthogonal views of an embodiment including a heating element located in an air stream upstream of the reference interferometer beam. The heating element in this embodiment is energized periodically by a pulse train of electrical power from a power source.

FIG. 5(A) is a time plot of electrical power pulses delivered to the heating element in the embodiment shown in FIG. 4(A).

FIG. 5(B) is a time plot of signals produced by the reference interferometer in FIG. 4(A) as heated air from the heating element passes across the interferometer beam.

FIG. 5(C) is a time plot of signals produced by the reference interferometer in FIG. 4(A) in the absence of units of heated air from the heating element passing across the interferometer beam.

FIG. 5(D) is a time plot of signals summed from FIGS. 5(B) and 5(C).

FIG. 6(A) is a plot of wire temperature versus time as the heating element is energized in a repetitively pulsed manner; data are presented for three different time constants at a pulse rate of 10 Hz.

FIG. 6(B) is a plot of wire temperature versus time as the heating element is energized in a repetitively pulsed manner; data are presented for three different time constants at a pulse rate of 5 Hz.

FIG. 7 is a plot of wire time-constants as a function of wire diameter for four different wire materials considered for use as a heating element. Air velocity=0.3 m/sec.

FIG. 8 is a control diagram of an embodiment of a fluctuation-corrected interferometer system.

FIG. 9(A) is a schematic diagram of an example embodiment of a microlithography system comprising at least one fluctuation-corrected interferometer system.

FIG. 9(B) is a schematic isometric view of a substrate stage, such as used in the system embodiment of FIG. 9(A), including at least one fluctuation-corrected interferometer system.

FIG. 9(C) is a schematic plan view of the substrate stage shown in FIG. 9(B).

FIG. 10 is a block diagram of a micro-device fabrication process including a wafer-processing step comprising a microlithography step performed using a microlithography system such as shown in FIG. 9(A), for example. The depicted process includes design of the function and performance characteristics of the micro-device.

FIG. 11 is a block diagram of representative details of a wafer-processing process including a microlithography step performed using a microlithography system such as shown n FIG. 9(A), for example.

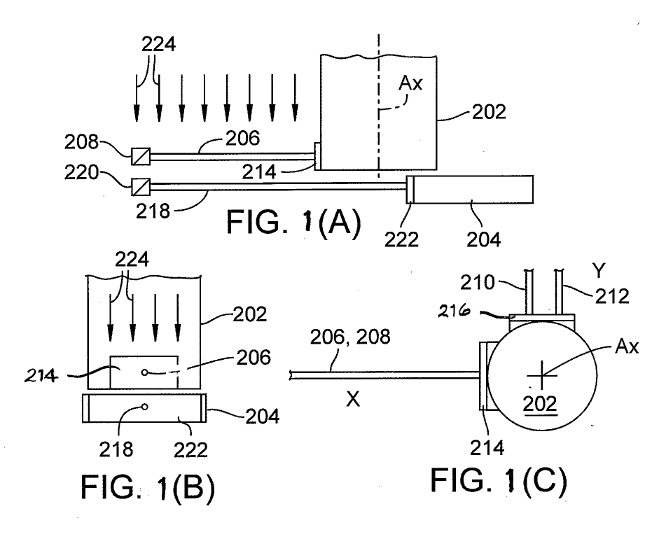

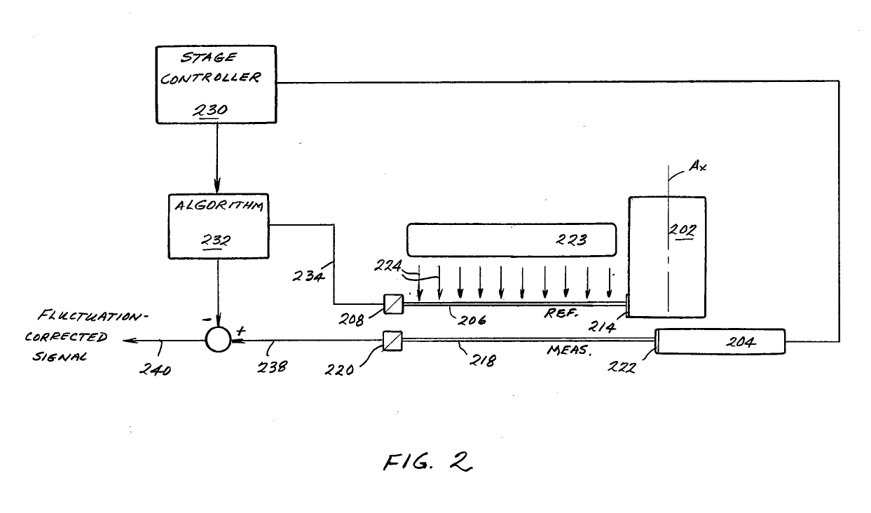

### DETAILED DESCRIPTION

This disclosure is set forth in the context of representative embodiments that are not intended to be limiting in any way.

As used in this application and in the claims, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another. The disclosed things and methods are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

As discussed above, the fluctuations from air turbulence in air flowing from a reference interferometer beam to a measurement interferometer beam are not constant; they fluctuate in time. This fluctuation adversely affects the phase of the correction that is applied by a conventional fixed algorithm to the measurement beam.

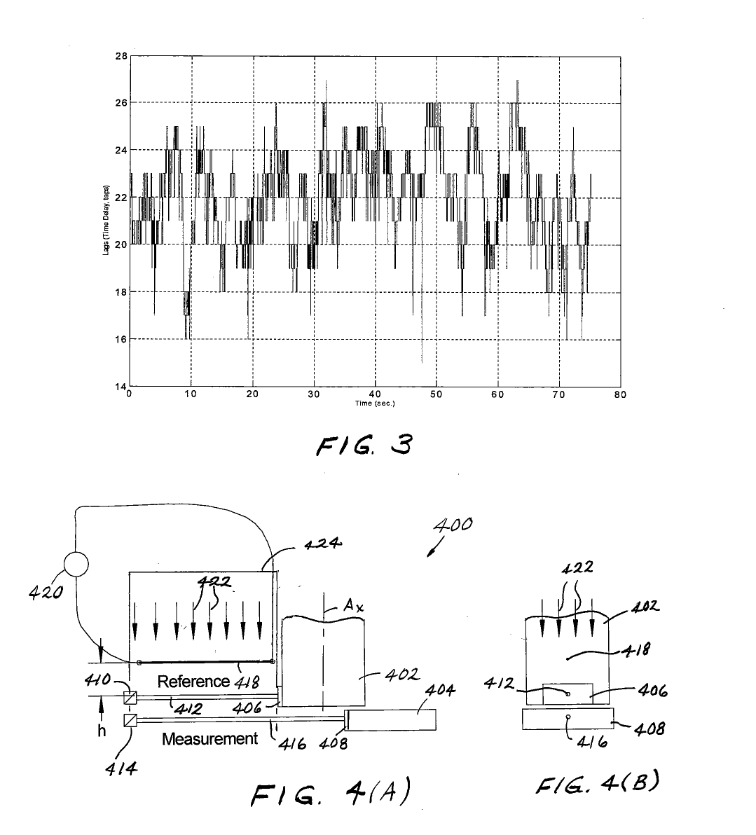

In various embodiments as disclosed herein, substantially real-time corrections are made to the predictive algorithm used for correcting measurement-interferometer data based on deliberate air-current perturbations detected by a corresponding reference interferometer. In other words, a known perturbation in time is introduced to the reference-interferometer signal, wherein the perturbation is related to the properties of air flow across the reference-interferometer beam. An embodiment 400 is shown in FIGS. 4(A)-4(B), in which a known perturbation over time is introduced to the reference-interferometer signal. The perturbation is related to the properties of the air flow past the reference beam. Shown are a projection-lens system 402 and a wafer stage 404 situated downstream of the projection-lens system 402 relative to the optical axis Ax. A mirror 406 is mounted to the projection-lens system 402 (or to an optical frame, not shown, to which the projection-lens system 402 is mounted). A mirror 408 is mounted to the wafer stage 404. A reference interferometer 410 directs a reference beam 412 to the mirror 406, and a measurement interferometer 414 directs an interferometer measurement beam 416 to the mirror 408. Situated above the reference beam 412 is an air source 423 (not shown) that releases a gentle flow of air (arrows 422) toward the reference beam 412. Situated between the reference beam 412 and the air source 424 is a resistive heater 418 that extends parallel to the reference beam. The distance between the resistive heater 418 and the reference beam 412 is denoted “h”. This distance is a key variable used in calculations involving air-flow velocity. The resistive heater 418 desirably is configured as a longitudinally extended wire or the like that is connected to a power supply 420 configured to generate a pulse train of electrical current. The resistive heater 418, reference beam 412, and measurement beam 416 are situated within a duct 422 or analogous enclosure.

The pulse train produced by the source 420 generally has a pre-set fixed frequency. As a pulse of electrical current is delivered to the resistive heater 418, the resistive heater produces a corresponding pulse of heat that is imparted to the air 422 passing by the resistive heater. An example temperature increase of the air is 50° C. above ambient, but this magnitude is not limiting. The heat pulses create small cells of heated air that flow (indicated by the arrows 422) to the reference interferometer beam 412, causing fluctuations in the reference beam. The air cells then proceed to the measurement interferometer beam 416. Based upon the pulse waveform, these deliberate perturbations imparted by the air cells in the environment of the reference beam can be separated (e.g., by use of a filter) from the data obtained by the reference interferometer. This separation is facilitated by the fact that the perturbations occur at a substantially fixed rate and have substantially equal magnitude, which produces accurate data regarding changing properties of the flowing air. Since the power spectrum of air-temperature fluctuations falls rapidly with increasing frequency, in many embodiments a repetition rat of 5-10 Hz generally allows a clean separation of the deliberate fluctuations from normal, non-deliberate, fluctuations, especially if filtering is used to perform the separation.

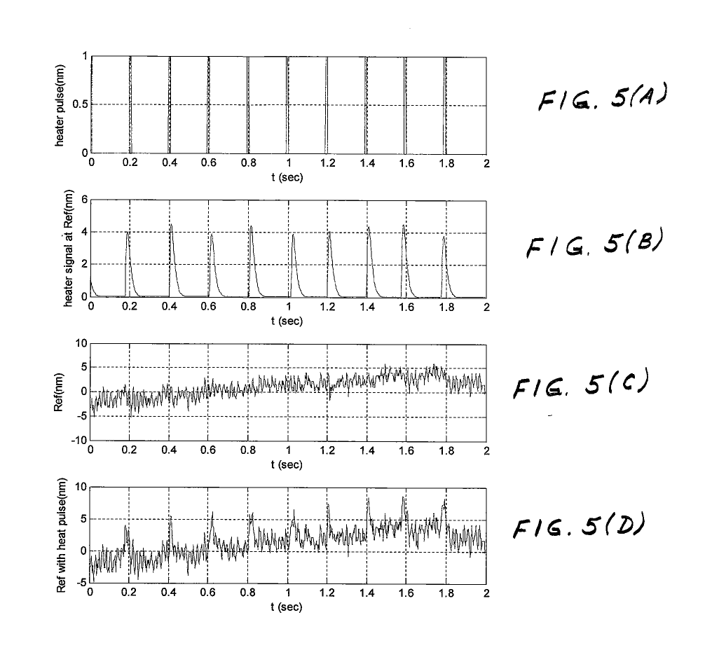

Plots of representative signals are provided in FIGS. (5A)-5(D). FIG. 5(A) is a plot of the pulse train delivered by the source 420 to the resistance heater 418. In this example, the pulse frequency is 5 Hz, in which a pulse is produced every 0.2 second. Note that the pulses are reproducible and at fixed intervals. Although the ordinate is in pulse units, it alternatively could be in units of electrical power, such as watts. FIG. 5(B) is a plot of corresponding signals as sensed at the reference beam 412. Although somewhat similar, the pulses exhibit some variation in shape, such as differences in amplitude for example. The pulses also have slightly variable arrival time. These differences reflect that, with each successive (and identical) pulse delivered to the resistance heater 418, the resulting effect on the air 422 is not identical. In addition, the pulse shape is asymmetric, reflecting the finite temperature-decay rate of the heater material. FIG. 5(C) is a plot of the reference-beam signal in the absence of pulses being delivered to the resistance heater 418; i.e., the power source 420 is off during the time the data of FIG. 5(C) were obtained. FIG. 5(D) is a plot of the reference-beam signal with pulses being delivered to the resistance heater 418. In the plot the peaks (corresponding to the peaks shown in FIG. 5(B)) are superimposed on the reference-beam signal of FIG. 5(C).

Passing the signal in FIG. 5(D) through a low-pass filter isolates the peaks reasonably well by removing high-frequency components of the signal. In other words, the signal fluctuations arising from operation of the resistance heater 418 (FIG. 5(B)) are separable from the original fluctuations (FIG. 5(C) because the fluctuations arising from the resistance heater occur at an approximately fixed repetition rate and amplitude. Although the fluctuations tend to increase the total interferometer fluctuations to be removed, the algorithm serves to correct for the fluctuations.

If the resistance heater 418 being turned on disturbs other portions of the lithography system, production and delivery of the pulses to the resistance heater can be limited, for example, to times in which exposures are not being made or otherwise when the added fluctuations do not disturb exposure. For example, the pulses can be produced during periods in which the stage 404 is turning around or while a substrate is being loaded or unloaded from the stage, during which the fluctuations normally do not cause a problem.

The resistance heater 418 in this embodiment comprises a wire as shown in FIG. 4. The power source 420 delivers sufficient power to the wire to raise the wire's temperature only slightly (e.g., 50° C.), which prevents significant thermal deformation of the wire. The wire material can be a suitable metal that has long life under the conditions of use, that is chemically inert in its usage environment and conditions, and that has a coefficient of thermal expansion suitable for preventing significant thermal distortion of the wire during use.

Alternatively to using a wire, the resistance heater 418 can comprise a resistance ribbon, which would provide more surface area than a wire. More surface area may provide more efficient heat transfer from the resistance heater 118 to the air 22. Another alternative configuration is of a helical wire coil, which may offer the same benefits as a resistance ribbon.

The air perturbations imparted by pulsing the resistance heater 418, made in the manner described above, are repetitive and have a substantially constant magnitude. These characteristics facilitate correction for their effects almost entirely. Also, even though a fairly large amplitude perturbation was used to obtain the data of FIGS. 5(A)-5(D), use of a low-pass filter to isolate the pulse train can allow a much smaller-amplitude signal.

The advantage of using a filter, such as a low-pass filter, to isolate further the interferometer response to the pulsed thermal perturbation must be weighed against the possible disadvantage of the unavoidable time delay associated with such filters. The time delay may make establishing real-time corrections to the correction algorithm more difficult.

The output of the filter provides an update to the algorithm. Multiple outputs over time provide an ongoing update (calibration) of the algorithm. This ongoing update can be in real time.

One can obtain further information about the change in fluctuation with height by adding additional resistive-heater wires at different heights above the measurement beam and pulsing them out of phase with each other or at incommensurate frequencies. A second reference beam would allow adaptation to be added to the algorithm, which can allow, for example, a check for motion of the optical system 402.

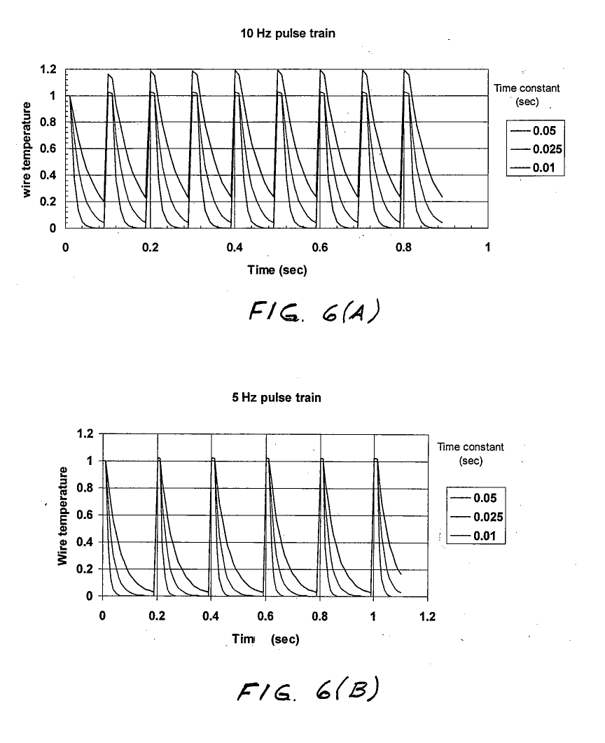

The wire of the resistance heater 418 desirably produces a sufficiently rapid temperature response to support stable heat-pulse trains. Also, the wire should be as thick as possible for safety. Regarding temperature response, after the wire receives a first power pulse, it is desirable that the temperature of the wire return to its initial (pre-pulse) value before commencing the next pulse. Reference is made to FIG. 6(A), which is a plot of wire temperature as a function of time, for three different representative time constants: 0.05, 0.025, and 0.01 second at a pulse frequency of 10 Hz. (These time constants assume exponential decay of wire temperature, with time after a pulse, to 0.37 of initial value.) The plot indicates that a time constant of 0.01 sec provides good separation of the temperature pulse peaks from each other. FIG. 6(B) is a similar plot for 5-Hz pulses. This plot indicates that time constants of 0.01 and 0.025 sec provide good separation of the temperature peaks.

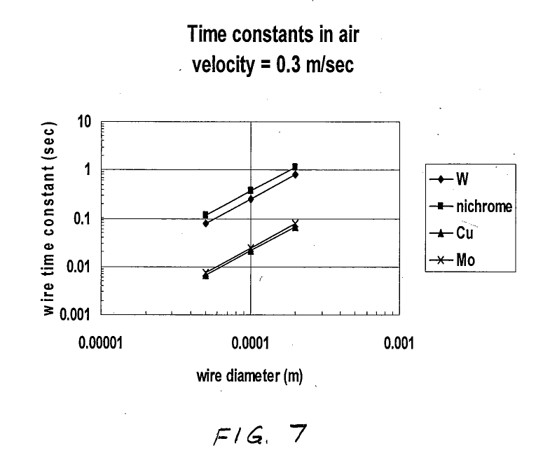

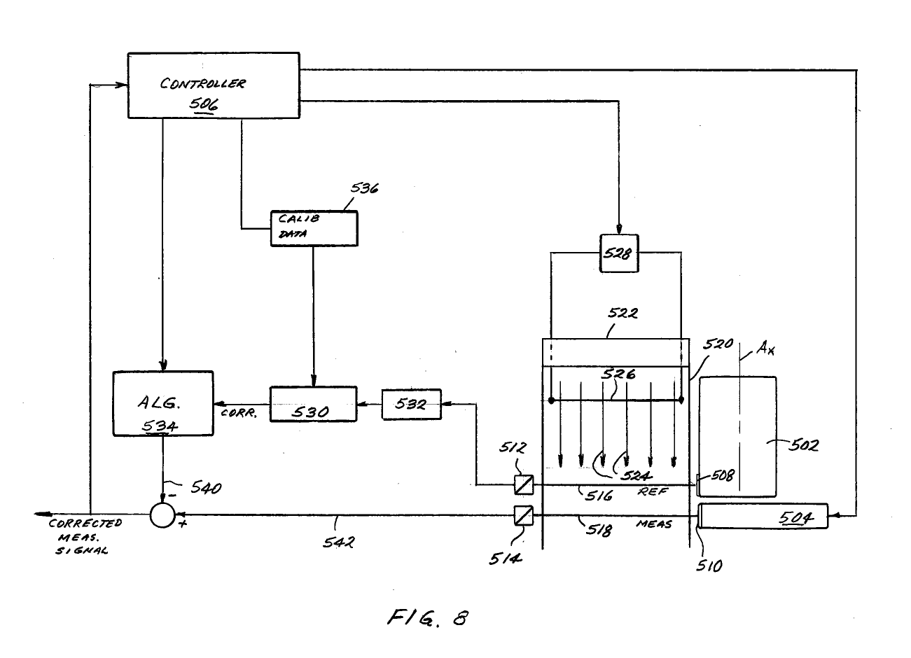

FIG. 7 is a plot of wire time constants as functions of wire diameter in air flowing at 0.3 m/sec. Copper and molybdenum wires of diameters ranging from 50 to 200 μm provide time constants in the range of about 0.007 second to 0.08 second. From these data, it is concluded that copper or molybdenum wire approximately 100 micrometers thick can be used for the wire in the resistance heater 418.

FIG. 8 is a block diagram of an embodiment of an interferometric position-measurement system 500. The system 500 comprises an optical system 502 having an optical axis Ax, a stage 504 that is movable relative to the optical system, and a controller 506. The optical system includes a stationary mirror 508, and the stage 504 includes a moving mirror 510. A reference interferometer 512 produces a reference beam 516, and a measurement interferometer 514 produces a measurement beam 518. The reference beam 516 reflects from the stationary mirror 508, and the measurement beam 518 reflects from the moving mirror 510. The interferometers 512, 514 and their respective beams 516, 518 are enclosed in a housing 520 into which air is introduced by an air source 522. The air flows in a downward direction (arrows 524) past the reference and measurement beams 516, 518. The housing 520 also includes a resistive heater 526 extending upstream of and parallel to the reference beam 516. The resistive heater 526 is powered in a repetitively pulsed manner by a power supply 528. The controller 506 is connected to the power supply 528 and to the stage 504. Position data obtained by the reference interferometer 512 is routed to a filter 530, desirably via a low-pass filter 532. In some embodiments there is no filter. In other embodiments the filter 532 is a band pass filter. If present, the filter 530 is connected to the algorithm processor 534, which also receives operational commands from the controller 506. Position data obtained by the reference interferometer 512 is also routed to a calibration processor 536. The calibration processor 536, also operating according to commands from the controller 506, generates calibrated data that are routed via a low-pass filter 538 to the filter 530. The output of the filter, comprising correction data, is routed to the algorithm processor 534 to update the algorithm therein. The algorithm processor 534 thus produces a fluctuation-corrected command 540, based upon what is occurring with actual air fluctuations in the air through which the reference beam 516 propagates. The corrected command 540 is subtracted from the measurement-interferometer signal 542, and the result can be fed back to the controller 506 and/or fed back to the filter 530. This embodiment can provide substantially real-time correction data that yield a more accurate control of stage position relative to the optical system 502, compared to conventional control systems.

### Microlithography System

The aspects of the invention described above are especially applicable to precision systems, of which an exemplar is a microlithography system.

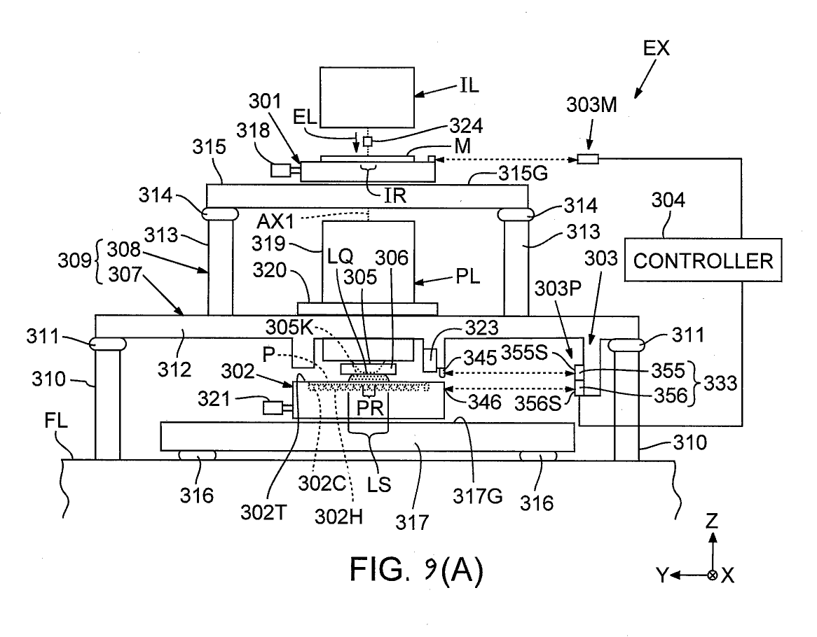

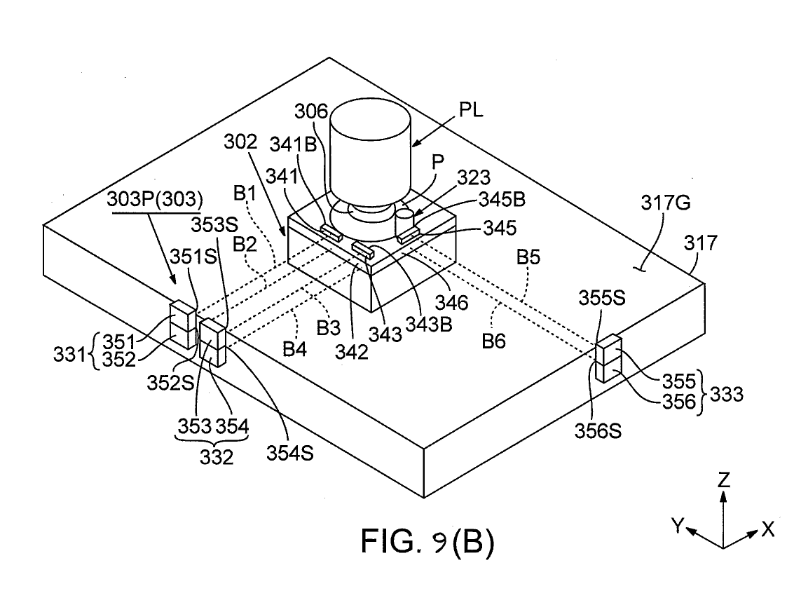

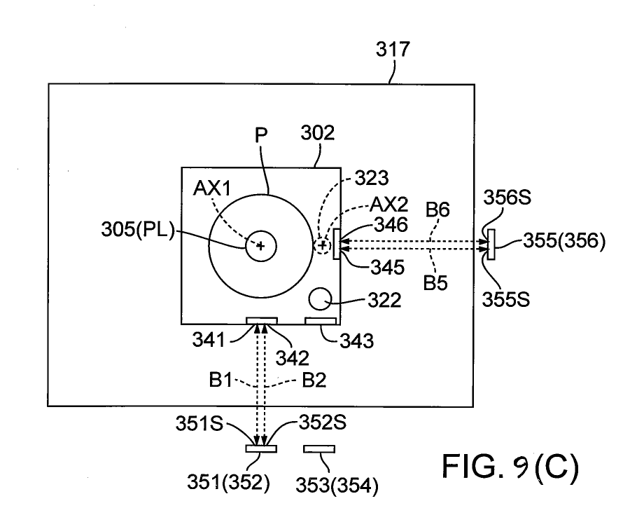

FIGS. 9(A)-9(C) schematically depict an example embodiment of a microlithography system EX comprising features as described above. In FIG. 9(A) the microlithography system EX comprises a reticle stage 301 that is movable while holding a patterned reticle M, a substrate stage 302 that is movable while holding a substrate P, a first driving system 318 that controllably moves the reticle stage 301, a second driving system 321 that controllably moves the substrate stage 302, a measurement system 303 that includes laser interferometers for measuring and obtaining position data for the reticle stage 301 and substrate stage 302, an illumination-optical system IL that illuminates the reticle M with an energy beam EL, a projection-optical system PL that projects the image of the pattern on the reticle M illuminated by the energy beam EL onto the substrate P, and a controller 304 that controls the operation of the entire microlithography system EX.

The substrate P referred to herein is a substrate used for fabricating micro-devices. The substrate P is a semiconductor wafer, e.g., a silicon wafer, or other suitable substrate on which a photosensitive film has been formed. The photosensitive film is of photosensitive material (“photoresist”). Alternatively, the substrate P may have different types of films formed thereon such as a protective film (top-coat film) aside from a photosensitive film. The reticle M (also called a “mask”) defines a device pattern to be projected onto the substrate P. An example of a reticle is a transparent plate member, such as a glass plate, on which a given pattern has been formed using a light-shielding film such as chrome. This transmissive reticle is not limited to a binary reticle onto which a pattern is formed with a light-shielding film, but also includes a phase-shift mask such as a half-tone phase-shift mask or a spatial frequency-modulated phase-shift mask. Alternatively, a reflective reticle can be used, especially if the exposure wavelength requires a reflective reticle.

In the present embodiment, descriptions will be given using an example where the microlithography system EX is an immersion-exposure system that exposes the substrate P with an energy beam EL through a liquid LQ. In this embodiment, a liquid immersion space LS is formed such that the liquid LQ fills the space of the optical path of the energy beam EL on the image-plane side of an endmost optical element 305, closest to the image plane of the projection-optical system PL among a plurality of optical elements of the projection-optical system PL. The space of the optical path of the energy beam EL is a space that includes the optical path through which the energy beam EL passes. The liquid immersion space LS is a space filled with the liquid LQ. In this embodiment, water (purified water) is used as the liquid LQ.

The microlithography system EX comprises a liquid-immersion member 306 used for forming the liquid space LS. The liquid-immersion member 306 is located near the endmost optical element 305. The liquid-immersion member 306 can be as disclosed in International Published Patent Application No. 2006/106907, for example. The liquid-immersion space LS is formed between the endmost optical element 305 and the liquid-immersion member 306 and the object arranged in a position facing the endmost optical element 305 and the liquid-immersion member 306. In this embodiment, objects that can be placed in the position facing the endmost optical element 305 and the liquid-immersion member 306 include the substrate stage 302 and the substrate P held by the substrate stage 302.

In this embodiment, the microlithography system EX utilizes a local liquid-immersion method in which the liquid-immersion space LS is formed such that a region on the substrate P that includes a projection region PR of the projection-optical system PL is partially covered by the liquid LQ.

The microlithography system EX in this embodiment is a scanning-type exposure system (what is called “scanning stepper”) that projects the image of the pattern on the reticle M onto the substrate P while synchronously moving the reticle M and the substrate P in a given scan direction. When the substrate P is exposed, the reticle M and the substrate P are moved in a given scan direction in the XY plane that intersects with an optical axis AX1 (optical path of the energy beam EL), of the projection-optical system PL, which is nearly parallel to the Z axis. In this embodiment, the scan direction (direction of the synchronous motion) of the substrate P is the Y-axis direction, and the scan direction (direction of the synchronous motion) of the reticle M is also the Y-axis direction. The microlithography system EX irradiates the energy beam EL onto the substrate P through the projection-optical system PL and the liquid LQ in the liquid-immersion space LS over the substrate P. Meanwhile, the system moves the substrate P in the Y-axis direction relative to the projection region PR of the projection-optical system PL, and also moves the reticle M in the Y-axis direction relative to an illumination region IR of the illumination-optical system IL in synchrony with the motion of the substrate P in the Y-axis direction. Thus, the image of the pattern on the reticle M is projected onto the substrate P, and the substrate P is exposed with the energy beam EL.

The microlithography system EX comprises a body 309 that includes a first column 307 provided on a floor FL and a second column 308 provided on the first column 307. The first column 307 comprises a plurality of first pillars 310 provided on the floor FL and a first surface plate 312 supported by the first pillars 310 via first anti-vibration devices 311. The second column 308 comprises a plurality of second pillars 313 provided on the first surface plate 312 and a second surface plate 315 supported by the second pillars 313 via second anti-vibration devices 314. The exposure system EX also comprises a third surface plate 317 supported by the floor FL via third anti-vibration devices 316. Each of the first anti-vibration devices 311, second anti-vibration devices 314, and third anti-vibration devices 316 includes an active anti-vibration device comprising respective actuators and damper mechanisms.

The illumination-optical system IL illuminates the given illumination region IR on the reticle M with the energy beam EL having a uniform illumination-intensity distribution. As the energy beam EL emitted from the illumination-optical system IL, emission lines (g-line, h-line, i-line) emitted from a mercury lamp, deep ultraviolet lights (DUV light) such as a KrF excimer laser light (with a wavelength of 248 nm), vacuum ultraviolet (VUV) light such as an ArF excimer laser light (with a wavelength of 193 nm) or an F₂ laser light (with a wavelength of 157 nm) can be used, for example. In this embodiment, an ArF excimer laser light, which is a VUV light, is used as the energy beam EL.

The reticle stage 301 is made movable by the first driving system 318 that includes an actuator such as a linear motor while holding the reticle M. The reticle stage 301 moves on the second surface plate 315. The second surface plate 315 has a guide surface 315G that movably supports the reticle stage 301. The guide surface 315G is nearly parallel to the XY plane. The reticle stage 301 is movable in the XY plane that includes the location at which the energy beam EL from the illumination-optical system IL is irradiated. In this embodiment, the location at which the energy beam EL from the illumination-optical system IL is irradiated includes the location that intersects the optical axis AX1 of the projection-optical system PL. Furthermore, the reticle M held by the reticle stage 301 is also movable in the XY plane that includes the location at which the energy beam EL from the illumination-optical system IL is irradiated. In this embodiment, the reticle stage 301 is movable in the X-axis, Y-axis, and θ_{Z} directions.

The projection-optical system PL projects the image of the pattern, defined on the reticle M, onto the substrate P at a certain projection magnification. Multiple optical elements of the projection-optical system PL are mounted in a “barrel.” The barrel 319 has a flange 320, and the projection-optical system PL is supported by the first surface plate 312 via the flange 320. An anti-vibration device can be arranged between the first surface plate 312 and the flange 320 (barrel 319).

The projection-optical system PL in this embodiment is a reduction system, with a projection magnification such as ¼, ⅕, or ⅛. The projection-optical system PL can also be either a 1× system or a magnification system. In this embodiment, the optical axis AX1 of the projection-optical system PL is parallel to the Z axis. Furthermore, the projection-optical system PL can be any of a dioptric system that does not include catoptrical elements, a catoptrical system that does not include dioptric elements, or a catadioptric system that includes dioptric elements and catoptrical elements. In addition, the projection-optical system PL may form either an inverted image or an erected image.

The substrate stage 302 is made movable by the second driving system 321, including an actuator such as a linear motor, while holding the substrate P. The substrate stage 302 moves on the third surface plate 317. The third surface plate 317 has a guide surface 173G that movably supports substrate stage 302. The guide surface 317G is nearly parallel to the XY plane. The substrate stage 302 is movable in the XY plane that includes the location where the energy beam EL from the endmost optical element 305 (projection-optical system PL) is irradiated. In this embodiment, the location where the energy beam EL from the endmost optical element 305 is irradiated includes the location facing an exit plane 305K of the endmost optical element 305 and the location that intersects with the optical axis of the endmost optical element 305 (optical axis AX1 of the projection-optical system PL). In addition, the substrate P held by the substrate stage 302 is also movable in the XY plane that includes the location where the energy beam EL from the endmost optical element 305 (projection-optical system PL) is irradiated. In this embodiment, the substrate stage 302 is movable in six directions: X axis, Y axis, Z axis, θ_{X}, θ_{Y}, and θ_{Z}.

The substrate stage 302 has a substrate chuck 302H that holds the substrate P, and has an upper surface 302T arranged around the substrate chuck 302H. The upper surface 302T of the substrate stage 302 is a flat surface that is nearly parallel to the XY plane. The substrate chuck 302H is located in a concave area 302C arranged on the substrate stage 302. The substrate chuck 2H holds the substrate P such that the surface of the substrate P is nearly parallel to the XY plane. The surface of the substrate P held by the substrate chuck 302H and the upper surface 302T of the substrate stage 302 are placed in nearly the same plane and thus are nearly coplanar.

Further with respect to FIG. 9(A), the microlithography system EX in this embodiment comprises a first detection device 323 for acquiring position data concerning the shot region on the substrate P. The first detection device 323 includes an off-axis-type alignment system arranged near the projection-optical system PL. At least some part of the first detection device 323 is located near the projection-optical system PL. The first detection device 323 is able to detect alignment marks AM on the substrate P and first fiducial marks FM1 placed on the substrate stage 302 (reference plate 322; see FIG. 9(C)). The first detection device 323 in this embodiment adopts the FIA (Field Image Alignment) method, such as the one disclosed in the Japan Laid-Open Patent Application No. 4-65603 (corresponding to U.S. Pat. No. 5,493,403), where a broadband detection light flux that does not expose the photosensitive material on the substrate P is irradiated on target marks (such as the alignment marks AM formed on the substrate P and the first fiducial marks FM1). An image of the target mark imaged on the light-receiving surface by the reflected light from the target mark and an index (index mark placed on an index plate placed inside the first detection device 323) is taken using an imaging device (such as a CCD). The imaging signals are image-processed to measure the position of the marks.

In this embodiment, the first detection device 323 is located adjacent to the −Y side of the projection-optical system PL (endmost optical element 305). In this embodiment, the first detection device 323 is supported by the first surface plate 312.

The microlithography system EX in this embodiment also comprises a second detection device 324 for acquiring position information of the image of the pattern on the reticle M projected onto the image-plane side of the projection-optical system PL. The second detection device 324 includes a TTR (Through The Reticle) alignment system that uses a light having the wavelength of the exposure beam. At least some part of second detection device 324 is located near the reticle stage 301. The second detection device 324 is able to observe simultaneously a pair of alignment marks on the reticle M and a conjugate image through the projection-optical system PL of second fiducial marks FM2 placed on the substrate stage 302 (reference plate 322; see FIG. 9(C)) corresponding to the alignment marks. The second detection device 324 in this embodiment adopts the VRA (Visual Reticle Alignment) method, such as the one disclosed in Japan Laid-Open Patent Application No. 7-176468 (corresponding to U.S. Pat. No. 6,498,352), in which a light is irradiated on a mark, and image data of the mark imaged by an imaging device such as a CCD camera are image-processed to detect the position of the mark.

FIG. 9(B) is a schematic isometric view of an interferometer system 303P for the substrate stage. The interferometer system 303P has a first interferometer system 331, a second interferometer system 332, and a third interferometer system 333. The first interferometer system 331 is arranged on the −X side relative to the projection-optical system PL. The second interferometer system 332 is arranged on the −X side relative to the first detection device 323. The third interferometer system 333 is arranged on the −Y side relative to the first detection device 323. The first detection device 323 is arranged on the −Y side of the projection-optical system PL.

The first interferometer system 331 comprises a first interferometer 351 having a first beam-exit part 351S from which a first beam B1 is emitted and a second interferometer 352 having a second beam-exit part 352S from which a second beam B2 is emitted. The first and second interferometers 351 and 352 are laser interferometers, and the first and second beams B1 and B2 are laser beams. The first interferometer 351 obtains interferometric information based on the first beam B1 by irradiating the first beam B1 onto a first reflective surface 341 and receiving the reflected light of the first beam B1 irradiated on first reflective surface 341. The second interferometer 352 obtains interferometric information based on the second beam B2 by irradiating the second beam B2 onto a second reflective surface 342 and receiving the reflected light of the second beam irradiated on second reflective surface 42.

The first reflective surface 341 is a surface perpendicular to the X axis. That is, the first reflective surface 341 is a surface parallel to the YZ plane. For the first interferometer 351, the X axis is the measurement axis. The first beam B1 from the first interferometer 351 travels in the X-axis direction and is incident on the first reflective surface 341. The first interferometer 351 receives the first beam B1 reflected from the first reflective surface 341 and measures the position information of the first reflective surface 341 with respect to the X-axis direction.

The second reflective surface 342 is a surface perpendicular to the X axis. That is, the second reflective surface 342 is a surface parallel to the YZ plane. For the second interferometer 352, the X axis is the measurement axis. The second beam B2 from the second interferometer 352 travels in the X-axis direction and is incident on the second reflective surface 342. The second interferometer 352 receives the second beam B2 reflected from the second reflective surface 342 and measures the position information of the second reflective surface 342 with respect to the X-axis direction.

The first reflective surface 341 is arranged so as to be nearly stationary. In this embodiment, the first reflective surface 341 is arranged on a fixed member 341B that is fixed such that it is nearly stationary. The second reflective surface 342 is arranged on the substrate stage 302. The first interferometer system 331 measures the position information of the substrate stage 302 with respect to the X-axis direction based on the measurement results of the first interferometer 351 and the measurement results of the second interferometer 352.

The second interferometer system 332 comprises a third interferometer 353 having a third beam-exit part 353S from which a third beam B3 is emitted and a fourth interferometer 354 having a fourth beam-exit part 354S from which a fourth beam B4 is emitted. The third and fourth interferometers 353 and 354 are laser interferometers, and the third and fourth beams B3 and B4 are laser beams. The third interferometer 353 obtains interferometric data based on the third beam B3 by irradiating the third beam B3 onto a third reflective surface 343 and receiving the reflected light of the third beam B3 irradiated on the third reflective surface 343. The fourth interferometer 354 obtains interferometric data based on the fourth beam B4 by irradiating the fourth beam B4 onto the second reflective surface 342 and receiving the reflected light of the fourth beam B4 irradiated on the second reflective surface 342.

The third reflective surface 343 is a surface perpendicular to the X axis. That is, the third reflective surface 343 is a surface parallel to the YZ plane. For the third interferometer 353, the X axis is the measurement axis. The third beam B3 from the third interferometer 353 travels in the X-axis direction and enters the third reflective surface 343. The third interferometer 353 receives the light of the third beam B3 reflected from the third reflective surface 343 and measures the position information of the third reflective surface 343 with respect to the X-axis direction.

For the fourth interferometer 354, the X axis is the measurement axis. The fourth beam B4 from the fourth interferometer 354 travels in the X-axis direction and is incident on the second reflective surface 342. The fourth interferometer 354 receives the light of the fourth beam B4 reflected from the second reflective surface 342 and measures the position information of the second reflective surface 342 with respect to the X-axis direction.

The third reflective surface 343 is arranged to be nearly stationary. In this embodiment, the third reflective surface 343 is arranged on a fixed member 343B that is fixed such that it is nearly stationary. The second interferometer system 332 measures the position information of the substrate stage 302 with respect to the X-axis direction based on the measurement results of the third interferometer 353 and the measurement results of the fourth interferometer 354.

The third interferometer system 333 comprises a fifth interferometer 355 having a fifth beam-exit part 355S, from which a fifth beam B5 is emitted, and a sixth interferometer 356 having a sixth beam-exit part 356S from which a sixth beam B6 is emitted. The fifth and sixth interferometers 355 and 356 are laser interferometers, and the fifth and sixth beams B5 and B6 are laser beams. The fifth interferometer 355 obtains interferometric data based on the fifth beam B5 by irradiating the fifth beam B5 onto a fifth reflective surface 345 and receiving the reflected light of the fifth beam B5 irradiated on the fifth reflective surface 345. The sixth interferometer 356 obtains interferometric data based on the sixth beam B6 by irradiating the sixth beam B6 onto a sixth reflective surface 346 and receiving the reflected light of the sixth beam B6 irradiated on the sixth reflective surface 346.

The fifth reflective surface 345 is a surface perpendicular to the X axis. That is, the fifth reflective surface 345 is a surface parallel to the XZ plane. For the fifth interferometer 355, the Y axis is the measurement axis. The fifth beam B5 from the fifth interferometer 355 travels in the Y-axis direction and is incident on the fifth reflective surface 345. The fifth interferometer 355 receives the light of the fifth beam B5 reflected from the fifth reflective surface 345 and measures the position information of the fifth reflective surface 345 with respect to the Y-axis direction.

The sixth reflective surface 346 is a surface perpendicular to the Y axis. That is, the sixth reflective surface 346 is a surface parallel to the XZ plane. For the sixth interferometer 356, the Y axis is the measurement axis. The sixth beam B6 from the sixth interferometer 356 travels in the Y-axis direction and is incident on the sixth reflective surface 346. The sixth interferometer 356 receives the light of the sixth beam B6 reflected from the sixth reflective surface 346 and obtains position data regarding the sixth reflective surface 346 with respect to the Y-axis direction.

The fifth reflective surface 345 is arranged to be substantially stationary. In this embodiment, the fifth reflective surface 345 is arranged on a fixed member 345B that is fixed such that it is nearly stationary. The sixth reflective surface 346 is arranged on the substrate stage 302. The third interferometer system 333 obtains position data of the substrate stage 302 with respect to the Y-axis direction based on the measurement results of the fifth interferometer 355 and the measurement results of the sixth interferometer 356.

The first beam B1 and second beam B2 from the first interferometer system 331 travel in the X-axis direction towards the optical axis AX1 of the projection-optical system PL. The third beam B3 and the fourth beam B4 from the second interferometer system 332 travel in the X-axis direction toward the optical axis AX2 of first detection device 323. The optical axis AX1 of the projection-optical system PL and the optical axis AX2 of the first detection device 323 are arranged along a given axis parallel to the Y axis. The fifth beam B5 and the sixth beam B6 from the third interferometer system 333 travel in the Y-axis direction toward the optical axis AX1 of the projection-optical system PL and the optical axis AX2 of the first detection device 323.

Furthermore, the fixed member 41B having the first reflective surface 341 is located on the −X side relative to the projection-optical system PL and is fixed onto the first surface plate 312. The first reflective surface 341 is located on the −X side relative to the projection-optical system PL and is facing the −X direction. The fixed member 43B having the third reflective surface 343 is located on the −X side relative to the first detection device 323 and is fixed onto the first surface plate 312. The third reflective surface 343 is located on the −X side relative to the first detection device 323 is facing the −X direction. The fixed member 345B having the fifth reflective surface 345 is located on the −Y side relative to first detection device 323 and is fixed onto the first surface plate 312. The fifth reflective surface 345 is located on the −Y side relative to the first detection device 323 is facing the −Y direction.

The first reflective surface 341 of the fixed member 341B supported by the first surface plate 312 may be placed near the second reflective surface 342. Similarly, the third reflective surface 343 of the fixed member 343B supported by the first surface plate 312 may be placed near the second reflective surface 342. Similarly, the fifth reflective surface 345 of the fixed member 345B supported by the first surface plate 312 may be placed near the sixth reflective surface 346. Furthermore, by mounting the first, third, and fifth reflective surfaces 341, 343, 345 of the fixed members 341B, 343B, 345B, respectively, on the first surface plate 312, effects on the first, third, and fifth reflective surfaces 341, 343, 345 by the motion of the projection-optical system PL (barrel 319) are suppressed.

The second reflective surface 342 is located on the −X side relative to the substrate stage 302 and is facing the −X direction. The second reflective surface 342 has an outer shape that is long in the Y-axis direction. The sixth reflective surface 346 is located on the −Y side of the substrate stage 302 and is facing the −Y direction. The sixth reflective surface 346 has an outer shape that is long in the Y-axis direction.

FIG. 9(C) is a plan view from the +Z side. As shown in FIG. 9(C), in this embodiment, when the center position of the substrate P being held by the substrate stage 302 is in a position facing the beam-exit plane 305K of the endmost optical element 305 (position at which the center position of the substrate P corresponds to the optical axis AX1), the distance between the first beam-exit part 351S of the first interferometer system 331 and the first reflective surface 341, and the distance between the second beam-exit part 352S and the second reflective surface 342 almost coincide.

Meanwhile, the center position of the substrate P is the center position of the surface of the substrate P; that is, the center position of the substrate P in the XY plane.

The first interferometer system 331 measures and obtains, by using the first reflective surface 341 and the second reflective surface 342, position data regarding the substrate stage 302 with respect to the X-axis direction, at least whenever the center position of the substrate P held by the substrate stage 302 is in a position facing the beam-exit plane 305K of the endmost optical element 305.

Furthermore, as shown in FIG. 9(C), in this embodiment, whenever the center position of the substrate P held by the substrate stage 302 is in a position facing the beam-exit plane 305K of the endmost optical element 305 (position at which the center position of the substrate P corresponds to the optical axis AX1), the distance between the fifth beam-exit part 355S of the third interferometer system 333 and the fifth reflective surface 345, and the distance between the sixth beam-exit part 356S and the sixth reflective surface 346 almost coincide.

The third interferometer system 333 measures, by using the fifth reflective surface 345 and the sixth reflective surface 346, the position information of the substrate stage 302 with respect to the Y-axis direction at least when the center position of the substrate P held by the substrate stage 302 is in a position facing the beam-exit plane 305K of the endmost optical element 305.

The principles set forth in the foregoing disclosure further alternatively can be used with any of various other apparatus, including (but not limited to) other microelectronic-processing apparatus, machine tools, metal-cutting equipment, and inspection apparatus.

### Semiconductor-Device Fabrication

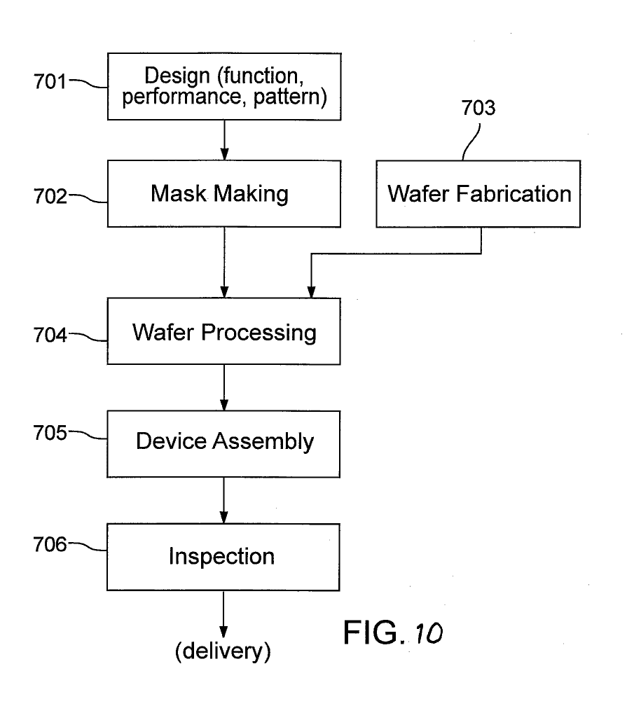

Semiconductor devices can be fabricated by processes including microlithography steps performed using a microlithography system as described above. Referring to FIG. 10, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

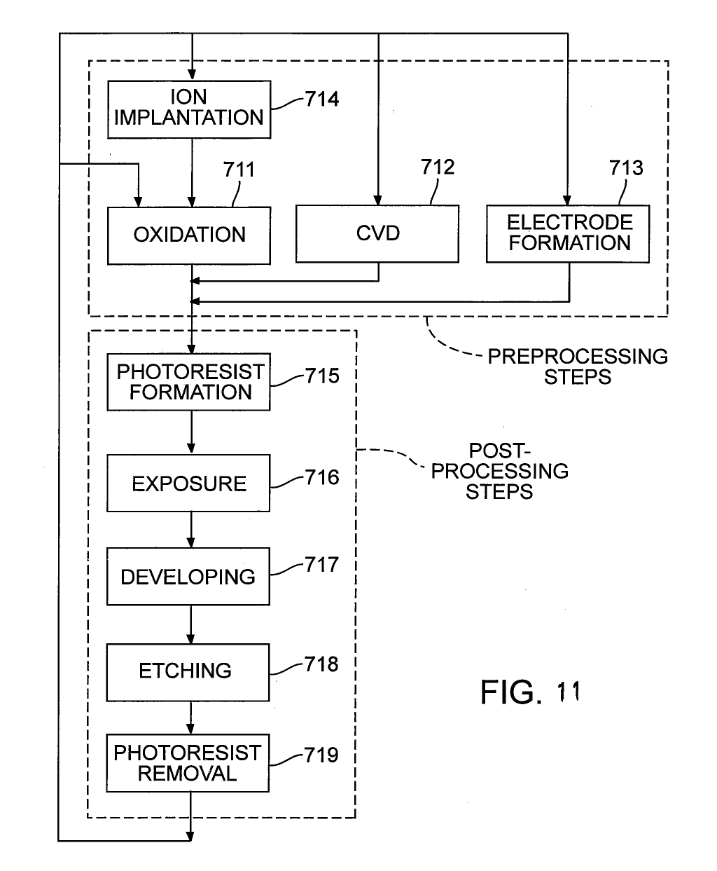

Representative details of a wafer-processing process including a microlithography step are shown in FIG. 11. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable reticle pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

Whereas the disclosure has been set forth in the context of multiple representative embodiments, it will be understood that the disclosure is not limited to those embodiments. On the contrary, the disclosure is intended to encompass all modifications, alternatives, and equivalents as may be included within the spirit and scope of the invention, as defined by the appended claims.

What is claimed is:

1. An interferometer system, comprising:
an interferometer producing data from at least one interferometer beam propagating in a beam pathway;
a source of an atmosphere flowing substantially normal to the beam pathway;
a perturbation source situated to perturb loci in the atmosphere in a repetitively pulsed manner in selected locations in the flowing atmosphere upstream of the beam pathway such that the perturbed loci flow to the at least one interferometer beam; and
a processor connected to receive the data from the interferometer, the processor being programmed with an algorithm that calculates, based on the data obtained during a perturbation pulse, an effect on the at least one interferometer beam of the perturbed loci in the flowing atmosphere due to the loci produced during the perturbation pulse reaching the interferometer beam, the processor also being configured to update the algorithm based on data obtained from the interferometer during a subsequent perturbation pulse.

2. The system of claim 1, wherein:
the interferometer is a reference interferometer; and
the at least one interferometer beam comprises a reference interferometer beam.

3. The system of claim 2, further comprising a measurement interferometer producing data from at least one measurement interferometer beam that are compared by the processor with data obtained from the reference interferometer beam.

4. The system of claim 3, wherein the measurement-interferometer beam is parallel to the reference-interferometer beam and situated such that the flowing atmosphere, with perturbed loci, reaches the measurement-interferometer beam after passing across the reference-interferometer beam pathway.

5. The system of claim 1, wherein the perturbation source comprises:
a resistance heater situated in the flowing atmosphere upstream of the interferometer beam; and
a repetitively pulsed power source connected to the resistance heater.

6. The system of claim 5, wherein the resistance heater comprises a wire extending parallel to the interferometer-beam pathway normal to a flow direction of the atmosphere.

7. The system of claim 3, wherein the reference and measurement interferometer beams are perturbed by the perturbation loci passing across respective propagation pathways of said beams.

8. An interferometer system, comprising:
a reference interferometer producing at least one reference beam;
a source of an atmosphere flowing in a direction substantially normal to the reference beam;
a measurement interferometer producing at least one measurement beam substantially parallel to the reference beam and situated in the atmosphere flow downstream of the reference beam;
a heat source situated to heat local portions of the atmosphere in a repetitively pulsed manner along a line substantially parallel to the reference beam but upstream of the reference beam in the atmosphere flow; and
a processor connected to the reference and measurement interferometers, the processor being programmed with an algorithm that, based on received data from the interferometers, calculates a correction to the measurement-beam data based on detected time delay of fluctuations in the reference and measurement beams caused by the heat source.

9. The system of claim 8, wherein the heat source is repetitively pulsed.

10. The system of claim 9, wherein the heat source operates at a pulse rate of 10 Hz or less in an atmosphere flow rate of 0.5 m/sec or less.

11. The system of claim 8, wherein the processor is further configured to detect changes in amplitude of interferometer signals caused by the heat source and to determine amplitude corrections based on the detected changes.

12. The system of claim 8, wherein the heat source comprises a wire extending parallel to the reference beam, and a repetitively pulsed electrical power supply connected to the wire to deliver an electrical current to the wire at a preset pulse rate.

13. The system of claim 12, wherein the heat source comprises multiple wires situated at different respective distances from the reference beam.

14. The system of claim 8, further comprising a filter connected to the reference interferometer to isolate perturbations of data from at least the reference interferometer caused by the heat source heating the atmosphere flowing past the reference and measurement beams.

15. The system of claim 14, further comprising a low-pass filter connected between the reference interferometer and the filter.

16. A method for determining position of an object using interferometry, the method comprising:
directing an interferometer beam along a beam pathway to the object so as to reflect from the object;
producing data from the interferometer beam regarding position of the object;
directing flow of an atmosphere substantially normal to the beam pathway;
in a repetitively pulsed manner, forming a first pulse of perturbed loci in selected locations in the flowing atmosphere upstream of the beam pathway such that the perturbed loci flow to and across the beam pathway;
using an algorithm, producing data from the interferometer beam as the perturbed loci pass across the beam pathway during a perturbation pulse;
during a subsequent perturbation pulse, producing data from the interferometer beam as the respective perturbed loci pass across the beam pathway; and
updating the algorithm based on a change in data obtained during the subsequent pulse compared to data obtained during the first pulse.

17. The method of claim 16, wherein forming the perturbed loci in the flowing atmosphere further comprises forming cells of heated air.

18. The method of claim 17, wherein forming cells of heated air comprises passing the atmosphere across a resistance heater that is powered in a repetitively pulsed manner.

19. The method of claim 16, wherein the interferometer beam is a reference interferometer beam.

20. The method of claim 19, further comprising:
directing a measurement-interferometer beam along a measurement-beam pathway such that the perturbed loci flow across the measurement-interferometer beam pathway after flowing across the reference-interferometer beam pathway;
producing data from the measurement-interferometer beam; and
comparing the data from the measurement-interferometer beam to the data from the reference-interferometer beam.

21. A precision system, comprising the interferometer system of claim 1.

22. The precision system of claim 21, configured as a microlithography system.

23. A precision system, comprising the interferometer system of claim 8.

24. The precision system of claim 23, configured as a microlithography system.

25. In a method for fabricating a micro-device, a microlithography step performed using the microlithography system of claim 22.

26. In a method for fabricating a micro-device, a microlithography step performed using the microlithography system of claim 24.

27. In a microlithography process, a method for determining position of an object as recited in claim 16.
